(19) United States
(12) Patent Application Publication
(10) Pub. No.: US 2006/0103678 A1
(43) Pub. Date: May 18, 2006

(54) Method and system for interactive visualization of locally oriented structures

(76) Inventors: Pascal Cathier, Bures (FR); Jonathan Stoeckel, Exton, PA (US)

Correspondence Address: Siemens Corporation;Intellectual Property Department, 170 Wood Avenue South, Iselin, NJ, 08830, US

(21) Appl. No.: 11/103,298

(22) Filed: Apr. 11, 2005

Related U.S. Application Data
(60) Provisional application No. 60/630,760, filed on Nov. 24, 2004.
(60) Provisional application No. 60/628,985, filed on Nov. 18, 2004.

(51) Int. Cl. G09G 5/00

(52) U.S. Cl. 345/649

(57) ABSTRACT

A method of visualizing an object in an image includes presenting an image, selecting a point in an object of interest in said image, determining a main orientation of said object of interest, presenting a first visualization of said object of interest, wherein said first visualization has a first display orientation characterized by the direction of a vector normal to the first visualization plane, and selecting a new point as a center of a new visualization and presenting said new visualization, wherein said new visualization has a new display orientation characterized by the direction of a vector normal to the new visualization plane.

### CROSS REFERENCE TO RELATED UNITED STATES APPLICATIONS

This application claims priority from “ADVANCED INTERACTIVE VISUALIZATION OF LOCALLY ORIENTED STRUCTURES”, U.S. Provisional Application No. 60/630,760 of Cathier, et al., filed Nov. 24, 2004, the contents of which are incorporated herein by reference, and “LOCAL VISUALIZATION TECHNIQUES FOR VESSEL STRUCTURES”, U.S. Provisional Application No. 60/628,985 of Cathier, et al., filed Nov. 18, 2004, the contents of which are incorporated herein by reference.

### TECHNICAL FIELD

This invention is directed to interactive visualization of vascular and other oriented structures in a digital medical image.

### DISCUSSION OF THE RELATED ART

The diagnostically superior information available from data acquired from current imaging systems enables the detection of potential problems at earlier and more treatable stages. Given the vast quantity of detailed data acquirable from imaging systems, various algorithms must be developed to efficiently and accurately process image data. With the aid of computers, advances in image processing are generally performed on digital or digitized images.

Digital images are created from an array of numerical values representing a property (such as a grey scale value or magnetic field strength) associable with an anatomical location points referenced by a particular array location. The set of anatomical location points comprises the domain of the image. In 2-D digital images, or slice sections, the discrete array locations are termed pixels. Three-dimensional digital images can be constructed from stacked slice sections through various construction techniques known in the art. The 3-D images are made up of discrete volume elements, also referred to as voxels, composed of pixels from the 2-D images. The pixel or voxel properties can be processed to ascertain various properties about the anatomy of a patient associated with such pixels or voxels. Computer-aided diagnosis (“CAD”) systems play a critical role in the analysis and visualization of digital imaging data.

An important application of computed tomographic (CT) imaging systems, as well as magnetic resonance (MR) imaging and 3-D x-ray (XR) imaging systems, is to produce 3D image data sets for vascular analysis, which can include analysis of a variety of tortuous tubular structures such as airways, ducts, nerves, blood vessels, etc. Production of such 3D image data sets is particularly important for radiologists, who are called upon to provide thorough visual reports to allow assessments of stenosis or aneurysm parameters, quantify lengths, section sizes, angles, and related parameters. Information concerning, for example, the most acute stenosis on a selected vessel section, the largest aneurysm on a selected vessel section, or the tortuosity of a vessel, is commonly utilized by physicians to allow for surgical planning. For productivity reasons, as well as to reduce film costs, the 3D image data sets should be limited to only a small set of significant images.

To facilitate the obtaining of useful information for vascular analysis in an efficient manner, conventional medical imaging systems sometimes provide 3D visualization software. Such software is provided either on the imaging, systems themselves or on analysis workstations, and provides a set of tools to perform length, angle or volume measurements and to visualize a volume in different ways, for example, using cross-sections, navigator or volume rendering. With respect to vascular analysis, in particular, the software can be used to obtain multiple oblique slices of a particular vessel to allow for analysis of the vessel.

Analyzing tortuous structures, such as airways, vessels, ducts or nerves is one of the major applications of medical imaging systems. This task is accomplished today by using multiple oblique slices to analyze local segments of these structures. These views lo provide a clear, undistorted picture of short sections from these objects but rarely encompass their full length. Curved reformation images provide synthetic views that capture the whole length of these tubular objects and are therefore well suited to this analysis task. True 3D length measurements along the axis can be obtained from these views and they are not too far from the real anatomy in many cases. Curved reformation images can be generated by sampling values along a curve at equidistant points to generate lines, and then translating this curve by a sampling vector to generate the next image line.

Therefore, new methods and apparatuses for allowing medical imaging systems and related 3D visualization software to produce useful 3D imaging data sets in a more efficient, consistent, repeatable, rapid, and less operator-dependent manner would be useful. New methods and apparatuses that facilitated vascular analysis, including the analysis and imaging of tubular vessels and related stenoses, aneurysms, and tortuosity, would also be useful. It further would be helpful if such methods and apparatuses could be employed both during imaging and in post-processing after imaging is completed.

### SUMMARY OF THE INVENTION

Exemplary embodiments of the invention as described herein generally include methods and systems for interactive visualization of local vessel structures and other tubular-like structures, and more generally for any structure for which an orientation can be locally defined, such as muscle fibers, neurons, etc. The techniques herein disclosed are improvements upon the techniques disclosed in U.S. patent applicant Ser. No. 10/945,022. “Method and System for Automatic Orientation of Local Visualization Techniques for Vessel Structures”, filed Sep. 20, 2004, the contents of which are herein incorporated by reference in their entirety. The techniques herein disclosed extend the techniques of these inventors' copending application “Method and System for Local Visualization for Tubular Structures”, U.S. patent application Ser. No. 10/---,---, filed concurrently herewith, the contents of which are herein incorporated by reference in their entirety.

In accordance with an aspect of the invention, there is provided a method for visualizing an object in an image, including presenting an image with a plurality of intensities corresponding to a domain of points in a D-dimensional space, selecting a point in an object of interest in the image, calculating a main orientation of the object of interest in a region about the selected point, presenting a first visualization of the object of interest about the main orientation, wherein the first visualization has a first display orientation characterized by the direction of a vector normal to the first visualization plane, and selecting a new point as a center of a new visualization of the object of interest, recalculating the main orientation of the object of interest, and presenting the new visualization about the recalculated main orientation, wherein the new visualization has a new display orientation characterized by the direction of a vector normal to the new visualization plane.

In a further aspect of the invention, the new display orientation is chosen to be as close as possible to the display orientation of the first visualization.

In a further aspect of the invention, the method further comprises selecting a second new point, wherein the display orientation of the new visualization is determined from the display orientation of the first visualization and a display orientation of a second visualization centered on the second new point.

In a further aspect of the invention, the method further comprises selecting a set of points between the first point and the new point, and presenting a succession of visualizations, each centered on one of the new set of points.

In a further aspect of the invention, the position of each point of the set of points is based on an interpolation of a path from the first point to the new point.

In a further aspect of the invention, the position of each point of the set of points is selected along a geodesic path between the first point and the new point.

In a further aspect of the invention, the position of each,point of the set of points is selected along a center-line of a segmentation.

In a further aspect of the invention, the display orientation of each visualization of the succession of visualizations is interpolated from the display orientation of the first visualization and the display orientation of the new visualization.

In a further aspect of the invention, the method further comprises navigating through the object of interest by presenting the succession of visualizations.

In a further aspect of the invention, the method further comprises storing the first point, the new point, and the selected set of points between the first and the new points, to form a stored set of points, reordering the stored set of points, and presenting as succession of visualizations based on the reordered set of points.

In a further aspect of the invention, the method further comprises displaying the selected point in one or more standard orientations.

In a further aspect of the invention, the method further comprises simultaneously presenting a plurality of visualizations, each in its own window, and synchronizing the plurality of visualizations so that a change of orientation in one window is reflected in each of the other windows.

In another aspect of the invention, there is provided a program storage device readable by, a computer, tangibly embodying a program of instructions executable by the computer to perform the method steps for visualizing an object in an image

### BRIEF DESCRIPTION OF THE DRAWINGS

FIG. 1 is a flow chart of a method for local visualization of a vessel structure, according to an embodiment of the invention.

FIG. 2 is a block diagram of an exemplary computer system for implementing a local visualization system, according to an embodiment of the invention.

FIG. 3 depicts a window presenting a slice perpendicular to a main object orientation axis with slices being rotated about the main object orientation axis in another window, according to an embodiment of the invention.

FIG. 4 depicts a main orientation axis of a tubular object and a display orientation of a viewing window for the object, according to an embodiment of the invention.

FIG. 5 depicts how a display orientation of a new point can be determined from the display orientations of a previous point, according to an embodiment of the invention.

FIG. 6 depicts how a display orientation of a new point can be determined from the display orientations of previous and next points, according to an embodiment of the invention.

FIG. 7 depicts an axial view of an exemplary tubular object, showing-the point about which the main orientation is calculated, along with the main orientation axis and minor axes, according to an embodiment of the invention.

FIG. 8 depicts a tubular object with intermediate points for generating an animated traversal of the object, according to an embodiment of the invention.

### DETAILED DESCRIPTION OF THE PREFERRED EMBODIMENTS

Exemplary embodiments of the invention as described herein generally include systems and methods for interactive visualization of locally oriented structures.

As used herein, the term “image” refers to multi-dimensional data composed of discrete image elements (e.g., pixels for 2-D images and voxels for 3-D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R, the methods of the inventions are not limited to such images, and can be applied to images of any dimension, e.g. a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

Vascular structures are examples of tubular-shaped objects, which are commonly found in medical images. Other examples of tubular objects in medical images can include vessels, bronchi, bowels, ducts, nerves and specific bones. Representation and analysis of tubular objects in medical images can aid medical personnel in understanding the complex anatomy of a patient and facilitate medical treatments. When reviewing 3D images of vascular structures such as CT scans, a physician can use axial slices to detect any abnormal structures (e.g. nodules or emboli), but to further analyze the shape of the structure, additional views are useful. One possibility is the cartwheel projection, where the projection plane is turned around an axis. It makes it easier for a physician to assess whether a structure is round or not. Another possibility is to analyze projection planes orthogonal to the vessel axis. These techniques require an axis as an input. This axis should preferably be the axis of the vessel. Taking an arbitrary axis by default can sometimes yield bad visualization results.

In a typical analysis situation, a physician reviews a volumetric image, such as a CT image of the lungs, looking for spherical structures. The images are huge in all three dimensions. Usually the physician only looks at axial images, i.e. X-Y slices of the volume, one at a time, usually starting from the head down, and-back. The slices are typically 512×512 pixels, while the structures the physician is looking at are typically a few pixels wide. So, while the physician can easily dismiss most of the image, sometimes he or she may want to have a closer look at a structure. What's more, when having a closer look, he or she may want to have full 3D information, instead of just the X-Y cut.

A point in a tubular structure that has been selected, either automatically or manually by a user, can be the basis of visualizations using the methods disclosed in the inventors' copending application, “Method and System for Local Visualization for Tubular Structures”. When a new point is selected, either manually or automatically, as the center of a visualization, the main orientation of the tubular structure can be calculated and the visualization can be updated as if this was the original selected point.

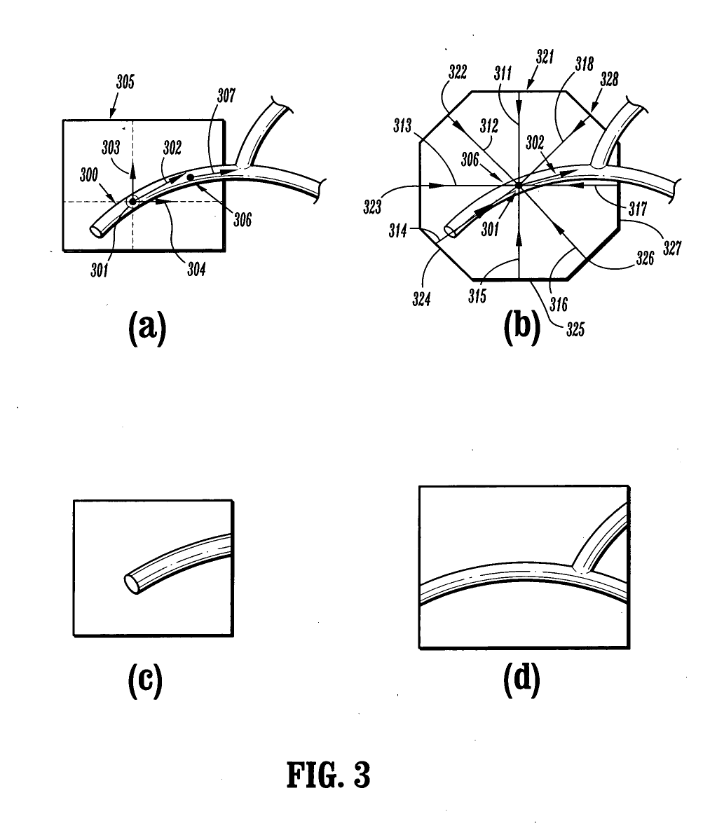

According to an embodiment of the invention, at each new point, one or more of visualization methods, such as those disclosed in copending application “Method and System for Local Visualization for Tubular Structures”, can be presented simultaneously in their own windows and be synchronized with each other so that a change of orientation or view in one window is reflected in each of the other windows. For example, a user could be presented with a slice perpendicular to the main object orientation axis in one window and with slices being rotated about the main object orientation axis in another window, as illustrated in FIG. 3. Referring to FIG. 3a, a tubular object 300 is shown, with a selected point 301, and main orientation axis 302 at point 301. Axes 303, 304 define a plane perpendicular to the main orientation axis 302, and FIG. 3c depicts a window in which slice 305 defined by the perpendicular axes 303, 304 is displayed. FIG. 3b depicts a plurality of viewing direction axes 311, 312, 313, 314, 315, 316, 317, 318 in the plane perpendicular to the object main orientation axis 302, and viewing planes 321, 322, 323, 324, 325, 326, 327, 328 each of which is normal to its respective direction axis. FIG. 3d depicts a window in which the viewing planes 321, 322, 323, 324, 325,.326, 327, 328 can be successively displayed, presenting the user with the impression of circling around the object displayed in FIG. 3c. As a user selects a new point 306 for recalculating the main orientation axis 307 in one window, the slices being presented in the other window will be re-orientated to reflect the new main orientation axis.

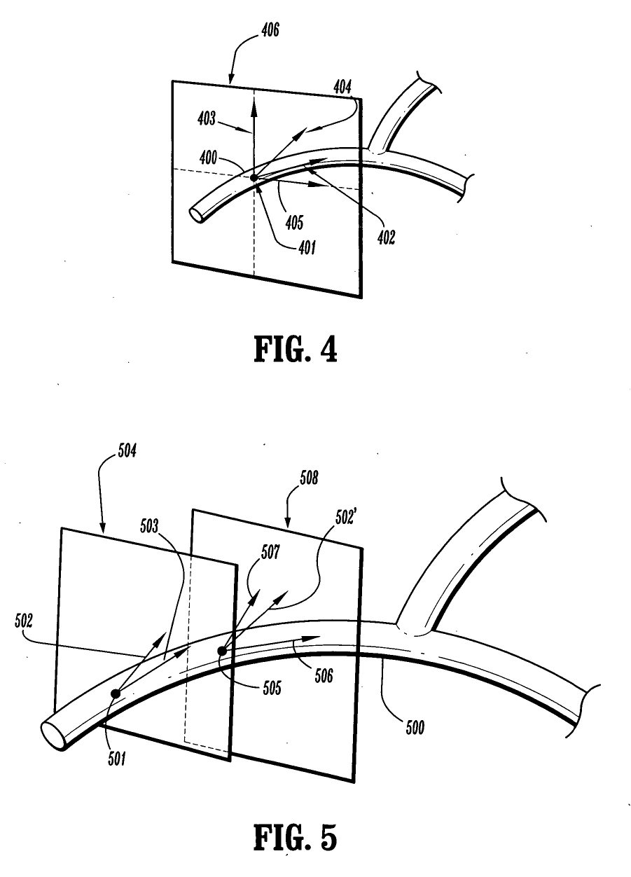

Finding the main orientation of a tubular structure leaves one free to choose a display orientation for the structure. This orientation can be characterized by the direction of a vector normal to the plane of the slice being presented to the user, as illustrated in FIG. 4. Referring to FIG. 4, tubular object 400 has main orientation direction 402 defined at point 401, while display plane 406 is defined by perpendicular axes 403, 405, and has a display orientation defined by the vector 404 normal to plane 406. The orientation used for display purposes can be chosen to meet specific requirements, and can be chosen to point in any direction, such as upward, rightward, etc. According to an embodiment of the inventions, one can use anatomical knowledge to determine a display orientation, e.g. in the case of lungs, one might want to have the orientation to point always in the direction of the heart, or in the direction of the pleura.

According to another embodiment of the invention, one can choose the display orientation of a subsequent point in such a way that the resulting visualization is as close as possible as that obtained based on a previous point. One technique of choosing such a display orientation is to choose the normal to the parallel plane being visualized to be as close as possible to the normal of the previously visualized plane, as illustrated in FIG. 5. Referring to the figure, tubular object 500 has a fist point about which a main orientation 503 has been determined, and is displayed in viewing plane 504 with a display orientation determined by the normal vector to the plane 502. A new point 505 is selected for display. The main orientation 506 of the object at the new point is determined, and a new display-orientation 507 is also determined. For illustrative purposes, the first display orientation vector 502′ has been translated to originate from the new point 505, and is shown next to new display orientation 507. The difference in direction of the first display orientation and the new display orientation is exaggerated for clarity.

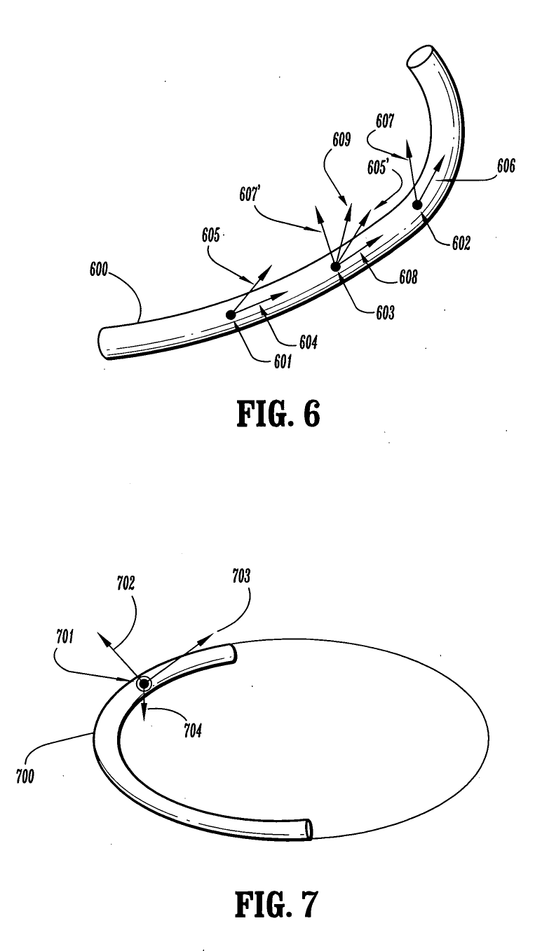

This principle can be applied to the other types of visualization. If a point has a previous and next point, the orientations obtained at both of those points can be used to determine the exact orientation at the current point in a similar way, as illustrated in FIG. 6. Referring to the figure, tubular object 600 has a first point 610, a second point 602, and a current point 603, with main orientations 604, 606, and 608, respectively. First point has a display orientation vector 605, and second point has a display orientation vector 607. For the purpose of clarity, the display windows corresponding to these display orientations are not shown. The current point 603 has display direction vector 609, which can be determined from the translated first and second display orientation vectors 605′ and 607′.

In many applications large parts of image planes are shown in standard orientations, such as the axial, coronal, or saggital orientations, or 3D renderings. If a user selects a point for a visualization using an automatic orientation method of the invention, this point can also be displayed in planes at one of the standard orientations. These visualizations can be updated automatically to show the plane or position that intersects with the point of interest. In addition, a marker, such as a dot, cross, or line segment, can show the position of the point, and an appropriate representation (e.g. lines, arrows) can show the orientation of the principal axes of the tubular structure and/or the two minor orientations. For example, FIG. 7 depicts an axial view of one exemplary tubular object, a rib bone 700. The point 701 about which the main orientation 703 was determined is indicated by a cross inside a circle, and minor orientations 702, 704 are also shown.

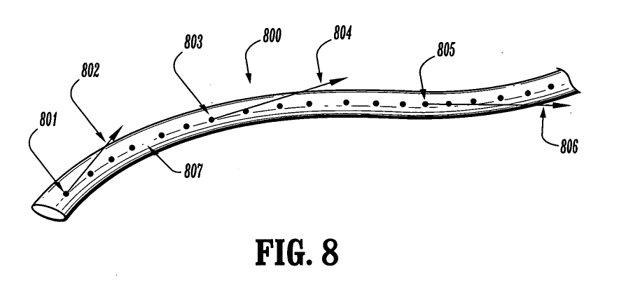

According to another embodiment of the invention, when a next point is chosen, visualizations based on automatically calculated points between the previous and the new point can be shown to simulate an animation. This animation will help users orient themselves and also decrease the number of points required to analyze a structure. According to this embodiment of the invention, to generate the position of these intermediate locations used in the animation, one can interpolate the new positions, using, for example, a linear interpolation or a cubic spline, or one can use image information such as a geodesic path or a center-line of a segmentation. To generate the orientation associated with these intermediate locations, either interpolation or image information can be used. FIG. 8 depicts a tubular object with intermediate points for generating an animated traversal of the object. Referring to the figure, tubular object 800 has three points 801, 803, 805 selected for determining their respective main orientations 802, 804, 806. In the interest of clarity, the viewing planes and display orientation vectors are not shown. A plurality of intermediate points 807 have been generated between the selected points about which new main orientation axes and new display orientation axes will be calculated. Note that a path connecting these points is a geodesic path that lies completely within the tubular object.

Similarly, an automatic navigation can be generated through the structure. The path can be determined either by image information, by extrapolation of the previous position or orientation, or any combination of these.

The points selected for visualizing the image or for navigating through a structure can be stored in such a way that, either automatically or manually, one can go through those points in any order, including the original order and an inverted order when requested.

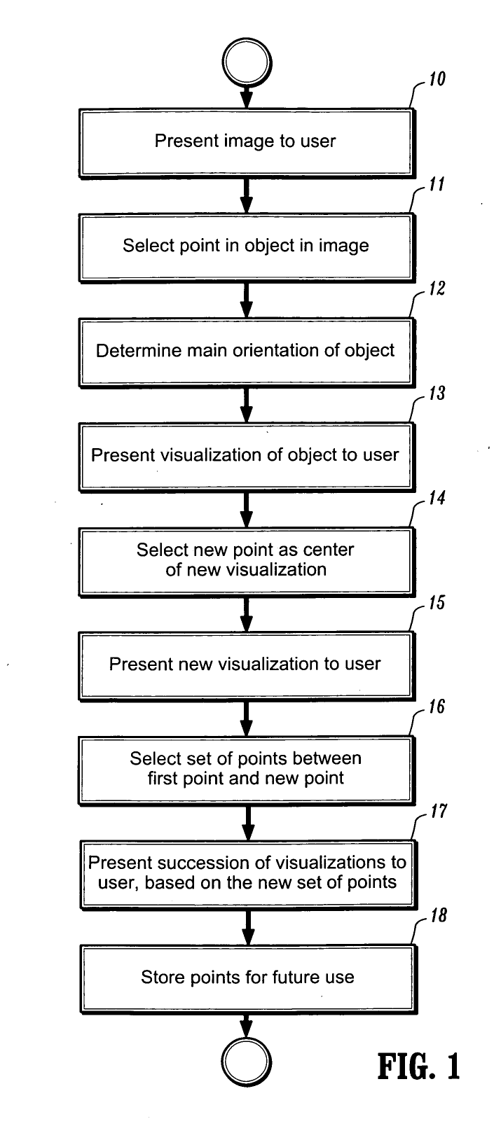

FIG. 1 presents a flow chart of a method of visualizing an object-of-interest in an image. Referring now to the figure, a user, such as a physician or a medical technician, is presented at step 10 with an image generated by a modality such as CT or MRI, as are known in the art. The image can be presented on the monitor of a computer system adapted to process and display digital medical images. At step 11, the user selects a first point in an object of interest in the image. The selection can be performed, for example, by the user clicking on the object of interest with a computer mouse or other input device. At step 12, the main orientation of the object of interest is calculated, and at step 13, a visualization of the object of interest is presented to the user. This visualization has a display orientation that can be, and typically will be different from the orientation of the object. This display orientation can be characterized by the direction of a vector normal to the visualization plane. At step 14, a new point is selected as a center of a new visualization. This new point can be selected manually by the user, or automatically by the system processing the image. This new visualization is presented to the user at step 15. The new visualization also has a display orientation characterized by the direction of a vector normal to the new visualization plane. At step 16, a set of points is selected between the first point and the new point, and a succession of visualizations, each centered on one of the new set of points, is presented to the user at step 17. At step 18, these points are stored for future use.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

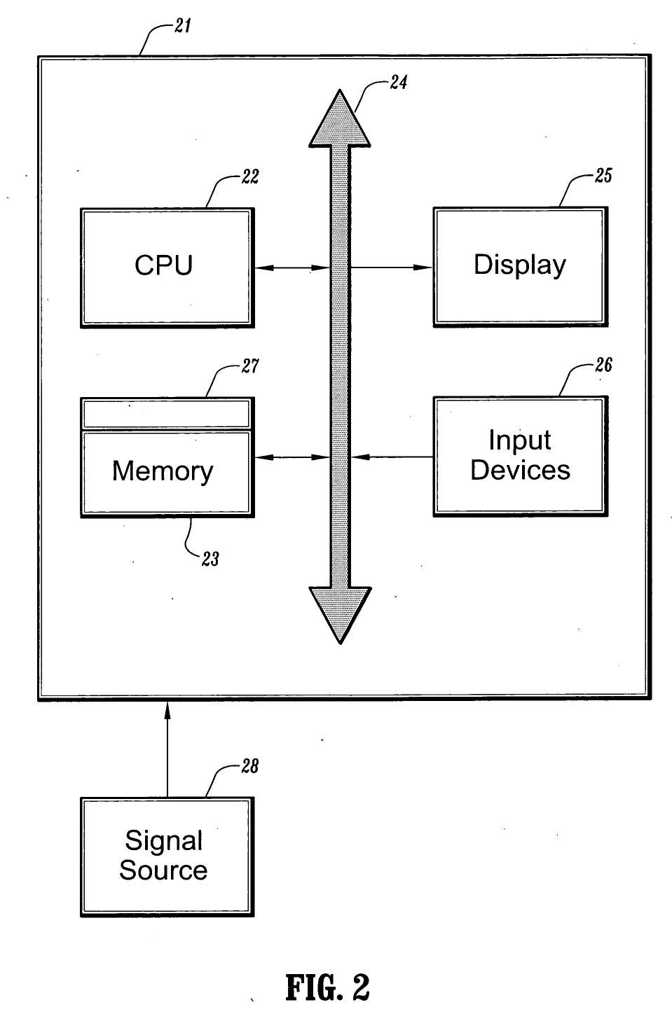

Referring now to FIG. 2, according to an embodiment of the present invention, a computer system 21 for implementing the present invention can comprise, inter alia, a central processing unit (CPU) 22, a memory 23 and an input/output (110) interface 24. The computer system 21 is generally coupled through the I/O interface 24 to a display 25 and various input devices 26 such as a mouse and a keyboard. The support circuits can include circuits such as cache, power supplies, clock circuits, and a communication bus. The memory 23 can include random access memory (RAM), read only memory (ROM), disk drive, tape drive, etc., or a combinations thereof. The present invention can be implemented as a routine 27 that is stored in memory 23 and executed by the CPU 22 to process the signal from the signal source 28. As such, the computer system 21 is a general purpose computer system that becomes a specific purpose computer system when executing the routine 27 of the present invention.

The computer system 21 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method of visualizing an object in an image, said method comprising the steps of:
presenting an image with a plurality of intensities corresponding to a domain of points in a D-dimensional space;
selecting a point in an object of interest in said image;
calculating a main orientation of said object of interest in a region about the selected point;
presenting a first visualization of said object of interest about said main orientation, wherein said first visualization has a first display orientation characterized by the direction of a vector normal to the first visualization plane; and
selecting a new point as a center of a new visualization of said object of interest, recalculating said main orientation of said object of interest, and presenting said new visualization about said recalculated main orientation, wherein said new visualization has a new display orientation characterized by the direction of a vector normal to the new visualization plane.

2. The method of claim 1, wherein the new display orientation is chosen to be as close as possible to the display orientation of the first visualization.

3. The method of claim 2, further comprising selecting a second new point, wherein the display orientation of the new visualization is determined from the display orientation of the first visualization and a display orientation of a second visualization centered on said second new point.

4. The method of claim 1, further comprising selecting a set of points between the first point and the new point, and presenting a succession of visualizations, each centered on one of the new set of points.

5. The method of claim 4, wherein the position of each point of the set of points is based on an interpolation of a path from the first point to the new point.

6. The method of claim 4, wherein the position of each point of the set of points is selected along a geodesic path between the first point and the new point.

7. The method of claim 4, wherein the position of each point of the set of points is selected along a center-line of a segmentation.

8. The method of claim 4, wherein the display orientation of each visualization of the succession of visualizations is interpolated from the display orientation of the first visualization and the display orientation of the new visualization.

9. The method of claim 4, further comprising navigating through said object of interest by presenting the succession of visualizations.

10. The method of claim 4, further comprising storing said first point, said new point, and said selected set of points between said first and said new points, to form a stored set of points, reordering said stored set of points, and presenting as succession of visualizations based on the reordered set of points.

11. The method of claim 1, further comprising displaying the selected point in one or more standard orientations.

12. The method of claim 1, further comprising simultaneously presenting a plurality of visualizations, each in its own window, and synchronizing said plurality of visualizations so that a change of orientation in one window is reflected in each of the other windows.

13. A method of visualizing a tubular object in an image, said method comprising the steps of:
presenting an image with a plurality of intensities corresponding to a domain of points in a D-dimensional space;
selecting a point in an object of interest in said image;
calculating a main orientation of said object of interest in a region about the selected point;
presenting a first visualization of said object of interest about said main orientation, wherein said first visualization has a first display orientation characterized by the direction of a vector normal to the first visualization plane;
selecting a new point in said object of interest; and
selecting a set of points between the first point and the new point, and presenting a succession of visualizations, each centered on one of the new set of points, wherein each said new visualization has a new display orientation characterized by the direction of a vector normal to the new visualization plane, wherein each new display orientation is chosen to be as close as possible to the display orientation of a previous visualization.

14. A program storage device readable by a computer, tangibly embodying a program of instructions executable by the computer to perform the method steps for visualizing an object in an image, said method comprising the steps of:
presenting an image with a plurality of intensities corresponding to a domain of points in a D-dimensional space;
selecting a point in an object of interest in said image;
calculating a main orientation of said object of interest in a region about the selected point;
presenting a first visualization of said object of interest about said main orientation, wherein said first visualization has a first display orientation characterized by the direction of a vector normal to the first visualization plane; and
selecting a new point as a center of a new visualization of said object of interest, recalculating said main orientation of said object of interest, and presenting said new visualization about said recalculated main orientation, wherein said new visualization has a new display orientation characterized by the direction of a vector normal to the new visualization plane.

15. The computer readable program storage device of claim 14, wherein the new display orientation is chosen to be as close as possible to the display orientation of the first visualization.

16. The computer readable program storage device of claim 15, the method further comprising selecting a second new point, wherein the display orientation of the new visualization is determined from the display orientation of the first visualization and a display orientation of a second visualization centered on said second new point.

17. The computer readable program storage device of claim 14, the method further comprising selecting a set of points between the first point and the new point, and presenting a succession of visualizations, each centered on one of the new set of points.

18. The computer readable program storage device of claim 17, wherein the position of each point of the set of points is based on an interpolation of a path from the first point to the new point.

19. The computer readable program storage device of claim 17, wherein the position of each point of the set of points is selected along a geodesic path between the first point and the new point.

20. The computer readable program storage device of claim 17, wherein the position of each point of the set of points is selected along a center-line of a segmentation.

21. The computer readable program storage device of claim 17, wherein the display orientation of each visualization of the succession of visualizations is interpolated from the display orientation of the first visualization and the display orientation of the new visualization.

22. The computer readable program storage device of claim 17, the method further comprising navigating through said object of interest by presenting the succession of visualizations.

23. The computer readable program storage device of claim 17, the method further comprising storing said first point, said new point, and said selected set of points between said first and said new points, to form a stored set of points, reordering said stored set of points, and presenting as succession of visualizations based on the reordered set of points.

24. The computer readable program storage device of claim 14, the method further comprising displaying the selected point in one or more standard orientations.

25. The computer readable program storage device of claim 14, the method further comprising simultaneously presenting a plurality of visualizations, each in its own window, and synchronizing said plurality of visualizations so that a change of orientation in one window is reflected in each of the other windows.
